(19) United States
(12) Patent Application Publication
(10) Pub. No.: US 2008/0229361 A1
(43) Pub. Date: Sep. 18, 2008

(54) Initial Arrangement of Interactive Program Guide

(76) Inventors: Dean F. Jerding, Roswell, GA (US); Robert O. Banker, Cumming, GA (US); Arturo A. Rodriguez, Norcross, GA (US); Gregory S. Durden, Jonesboro, GA (US); Robert T. Van Orden, Norcross, GA (US); Jack Miller, Duluth, GA (US); Kevin Hill, Atlanta, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 12/127,968

(22) Filed: May 28, 2008

Related U.S. Application Data
(63) Continuation of application No. 09/518,041, filed on Mar. 2, 2000.

(51) Int. Cl. H04N 5/445

(52) U.S. Cl. 725/46

(57) ABSTRACT

A method and system for a programmable television services client device that enables a user to navigate to an individual television service and is coupled to a programmable television services server device is provided. The client device comprises a memory for storing data. The client device also includes an interactive program guide contained in the memory that displays program information received from the headend server device. The memory of the client device stores configuration information for a plurality of initial guide arrangements. One of the initial guide arrangements is denoted in the configuration information by either the subscriber or the system operator at the headend as the selected guide for implementation at any given time. The client device also includes a processor that is responsive to the interactive program guide and the configuration information and causes the client device to display program information according to the selected initial guide arrangement.

### CROSS REFERENCE TO RELATED APPLICATION

This application is a continuation of U.S. application Ser. No. 09/518,041, filed on Mar. 2, 2000, which is incorporated herein by reference in its entirety.

### FIELD OF THE INVENTION

This invention relates in general to television systems, and more particularly, to the field of interactive program guides.

### BACKGROUND OF THE INVENTION

Historically, television services have been comprised of analog broadcast audio and video signals. Cable television systems now receive broadcasts and retransmit them with other programming to subscribers over land-line networks, typically comprising fiber optic cable and/or coaxial cable. With the recent advent of digital transmission technology, cable television systems are now capable of providing much more than the traditional analog broadcast video. In addition, two-way and advanced one-way communications between a subscriber and a cable system headend are now possible.

In implementing enhanced programming, the home communication terminal (“HCT”), otherwise known as the settop box, has become an important computing device for accessing video services and navigating a subscriber through a maze of services available. In addition to supporting traditional analog broadcast video and functionality, digital HCTs (or “DHCTs”) now also support an increasing number of services which are not analog, but rather digital; are not basic broadcast, but rather two-way communication such as video-on-demand; and are not basic video, such as e-mail or web browsers. These are all in addition to the host of other television services which are increasingly being demanded by consumers, examples of which include audio and audio/visual programming, advance navigation controls, impulse pay-per-view technology, and on-line commerce. In addition to the interactive services, the increased bandwidth available through a digital television system has made it possible for a subscriber to have access to hundreds, or even thousands, of channels and/or services. Thus, in order to provide these more powerful and complex features, the simple conventional channel abstractions need to be extended beyond those which have traditionally been provided.

Each HCT and DHCT (collectively hereinafter “DHCT”) are typically connected to a cable or satellite television network. The DHCTs generally include hardware and software necessary to provide the functionality of the digital television system at the client's site. Preferably, some of the software executed by a DHCT is downloaded and/or updated via the cable television network. Each DHCT typically includes a processor, a communication component and memory, and is connected to a television or other display device, such as a personal computer. While many conventional DHCTs are stand-alone devices that are externally connected to a television, a DHCT and/or its functionality may be integrated into a television or personal computer, as will be appreciated by those of ordinary skill in the art.

As more and more services and applications are provided, cable television systems are providing television program information to the DHCT so that the subscriber can view the program information on the DHCT display such as the television. This program information has traditionally been organized for presentation purposes into a program guide format that presents the program information by time and channel only. The program guide can, for instance, automatically scroll the available television channels to present the program information such as name and title, by time.

Many cable system operators include one or more dedicated channels that scroll through the channel list displaying the programs that not only are currently on, but also are scheduled to be on in the future. These types of passive displays do not rely on a terminal for presentation of the programming data and also lack the interactive functionality of permitting a subscriber to scroll to a desired channel for a desired time. For example, the subscriber typically must view the programming information as it scrolls on the display and wait for either the desired channel and/or the desired time to search for the program that may be available for viewing.

With the advent of program guide “browsers” for use in cable television systems, viewers (also referred to as “subscribers” or “users”) can literally scan program information by time and channel while watching the tuned channel. In analog systems that offer a limited number of cable television channels, these browsers enable the viewer to easily scan available programs one-by-one in order of channel number. However, many digital systems can provide hundreds or even thousands of channels. In such systems, scanning program information by channel numbers sequentially can require many keystrokes by the viewer and can consume tremendous amounts of time. Additionally, locating a particular channel can be quite tedious if the viewer does not already know the channel number for the channel for which it is desired. Traditional program guides have also typically been little more than grids with the channel time and number presented on x and y axes respectively; moreover, traditional systems have failed to flexibly provide the types of complex, graphically rich interactive program applications that are demanded by more sophisticated consumers of current digital systems. As a result, there is a need for interactive program guides that flexibly provide applications to enable viewers to easily and efficiently browse information about available programming and services.

### SUMMARY OF THE INVENTION

An object of the invention is to overcome the deficiencies and inadequacies as described in the previous section. Briefly described, the preferred embodiment of the present invention provides an apparatus and method for providing a plurality of navigable interactive program guide initial arrangements, or views, for selecting an individual television service or program.

A programmable television services client device that enables a subscriber to navigate to an individual television service that is coupled to a programmable television services server device is provided. The client device includes an interactive program guide contained in memory that displays program information received from the headend server device. The memory of the client device stores configuration information for a plurality of initial guide arrangements, as well as an indication of one of the initial guide arrangements denoted as the selected guide arrangement. In one embodiment of the present invention, the system operator at the headend selects the initial guide arrangement, and an indication of the selection is communicated to the client device. Another embodiment includes a mechanism for storing a viewer preference for the initial guide arrangement. The client device also includes a processor that, responsive subscriber input processes to the interactive program guide and the configuration information, causes the client device to display program information according to the selected guide arrangement.

In one of many embodiments of the present invention, an initial arrangement includes a subscriber browse-by format that includes a list of the guide arrangements on a portion of the guide so that the subscriber may interactively select a desired or preferred guide arrangement for locating an individual television service. In one such implementation, a default browse-by selection is included in the stored indication of the initial guide arrangements.

In an alternate embodiment, the subscriber selects and saves a mode from one or more configurable modes in which an interactive program guide (IPG) presents the initial displayed IPG presentation each time the subscriber invokes an IPG display session. Responsive to a first subscriber input, a first configurable mode displays an initial IPG presentation that lists a multiplicity of guide arrangements in which the subscriber provides secondary input to select a desired IPG presentation arrangement to initiate the current IPG session. Responsive to a first subscriber input, a second configurable mode displays an initial IPG presentation corresponding to the last IPG presentation arrangement effective at the time of exiting the last IPG display session. Responsive to a first subscriber input, a third configurable mode displays an initial IPG presentation corresponding to a preferred IPG presentation arrangement selected by subscriber during an interactive configuration session from a multiplicity of guide arrangements.

The preferred embodiment of the present invention has numerous advantages, a few of which are delineated hereafter, as merely examples.

One advantage of the preferred embodiment of the invention is that it flexibly and efficiently solves the problem of information overload that the subscriber might experience in attempting to navigate between hundreds of perhaps even thousands of potential channel viewing options.

Another advantage of the preferred embodiment of the present invention is that it enables the subscriber to instantly manipulate a list of selectable guide arrangements to permit a subscriber to take advantage of, for example, a time option, a theme option or a title option in locating a desired individual television service.

Other objects, features, and advantages of the present invention will become apparent to one with skill in the art upon examination of the following drawings and detailed description. It is intended that all such additional objects, features and advantages be included herein within the scope of the present invention as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a block diagram of a cable television system in accordance with one preferred embodiment of the present invention.

FIG. 2 is a block diagram of an DHCT and related equipment, in accordance with one preferred embodiment of the present invention depicted in FIG. 1.

FIG. 3 is a diagram of components located in the headend of the cable television system depicting files that are transferred across the system to the DHCT as shown in FIG. 1.

FIG. 4 is a diagram of the software support of the applications in the DHCT depicted in FIG. 2.

FIG. 5 is a diagram of the interactive program guide initial arrangement selection menu for a system operator at the headend to configure which initial management, or view, a client device will implement in accordance with the present invention as depicted in FIG. 2.

FIG. 6 is an example screen diagram that illustrates the initial guide arrangement in a time format that the DHCT as depicted in FIG. 2 presents the subscriber.

FIG. 7 is an example screen diagram that illustrates the guide arrangement in a modified time format for a current television program presented to a subscriber subsequent to the guide arrangement in FIG. 6.

FIG. 8 is an example screen diagram that illustrates the initial guide arrangement in a theme format that the DHCT as depicted in FIG. 2 presents the subscriber.

FIG. 9 is an example screen diagram that illustrates the guide arrangement in a modified theme format for a current television program presented to a subscriber subsequent to the guide arrangement in FIG. 8.

FIG. 10 is an example screen diagram that illustrates the initial guide arrangement in a title format that the DHCT as depicted in FIG. 2 presents the subscriber.

FIG. 11 is an example screen diagram that illustrates the guide arrangement in a modified title format for a current television program presented to a subscriber subsequent to the guide arrangement in FIG. 10.

FIG. 12 is an example screen diagram that illustrates the initial guide arrangement in a browse-by view theme format for a current television program that the DHCT as depicted in FIG. 2 presents the subscriber.

FIG. 13 is an example screen diagram that illustrates the initial guide arrangement in a browse-by time theme format for a current television program that the DHCT as depicted in FIG. 2 presents the subscriber.

FIG. 14 is an example screen diagram that illustrates the initial guide arrangement in a browse-by view title format for a current television program that the DHCT as depicted in FIG. 2 presents the subscriber.

### DETAILED DESCRIPTION OF THE PREFERRED EMBODIMENT

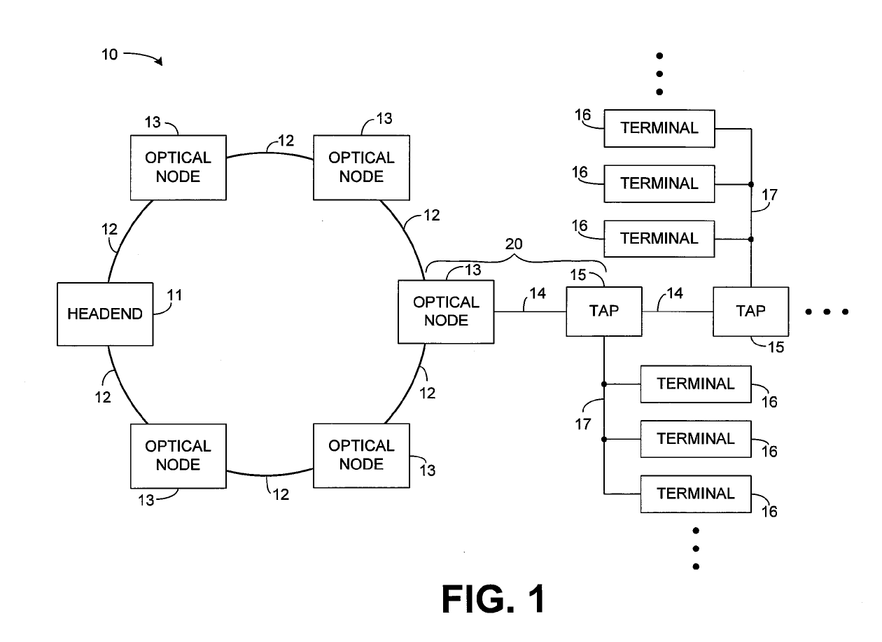

FIG. 1 is a block diagram of a cable television system 10 including a headend 11 for receiving television signals, such as satellite television signals, and converting the signals into a format for transmitting the signals over the system 10. The transmitted signals can, for example, be radio frequency (RF) signals or optical signals, as shown, transmitted over fiber optic cable 12. When the optical signals are transmitted by the headend 11, one or more optical nodes 13 are included in the system 10 for converting the optical signals to RF signals that are thereafter routed over other media, such as coaxial cables 14. Taps 15 are provided within the cable system 10 for splitting the RF signal off, via cables 17, to subscriber equipment such as DHCTs 16, cable-ready television sets, video recorders, or computers. Thus, headend 11 is connected through a network 20 to multiple DHCTs 16.

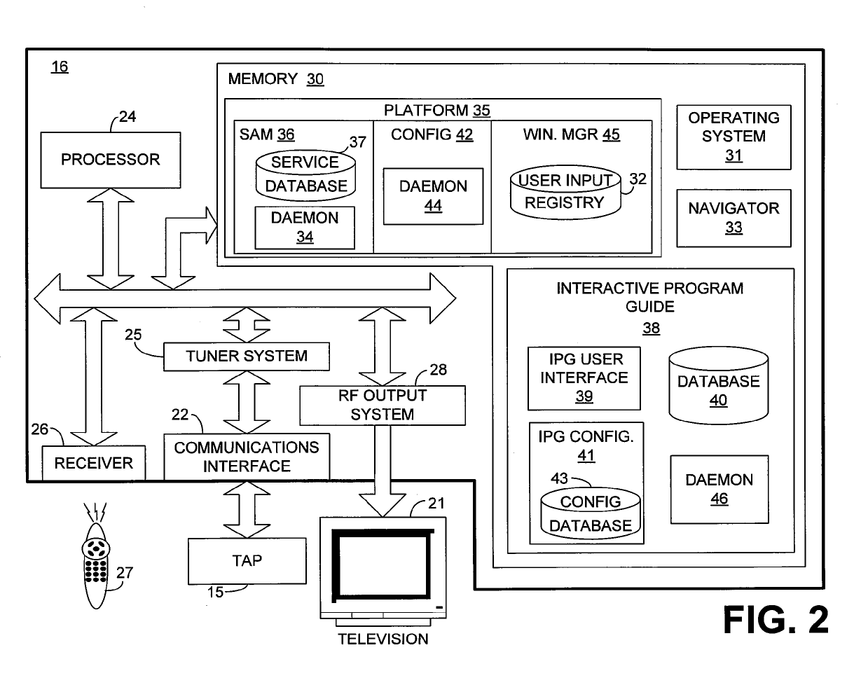

FIG. 2 is a block diagram illustrating the DHCT 16 and other system equipment. The DHCT 16 is typically situated within the residence or business of a subscriber. It may be integrated into a device that has a display 21, such as a television set, or it may be a stand-alone unit that couples to an external display 21, such as a display included in a computer or a television, and that processes television signals for presentation to a subscriber. The terminal 16 preferably comprises a communications interface 22 for receiving the RF signals, which can include video, audio and data information, from the tap 15 and for providing any reverse information to the tap 15 for transmission back to the headend 11 (FIG. 1). The DHCT 16 further includes a processor 24 for controlling operations of the DHCT 16, including a video output port such as an RF output system 28 for driving the display 21, a tuner system 25 for tuning into a particular television channel to be displayed and for sending and receiving various types of data from the headend 11. The tuner system includes in one implementation, an out-of-band tuner for bi-directional quadrature phase shift keying (QPSK) data communication and a quadrature amplitude modulation (QAM) tuner for receiving television signals. Additionally, DHCT 16 includes a receiver 26 for receiving externally-generated information, such as subscriber inputs or commands from other devices. The DHCT 16 may also include one or more wireless or wired communication interfaces, also called ports, for receiving and/or transmitting data to other devices. For instance, the DHCT may feature USB (Universal Serial Bus), Ethernet (for connection to a computer, IEEE-1394 (for connection to media devices in an entertainment center), serial, and/or parallel ports. The subscriber inputs may, for example, be provided by a computer or transmitter with buttons or keys located either on the exterior of the terminal or by a hand-held remote control device 27 or keyboard that includes subscriber-actuated buttons.

Memory 30, such as a non-volatile and dynamic random access memory, is coupled to the processor 24 and stores operational parameters, such as commands that are recognized by the processor 24. The most basic functionality of the DHCT 16 is provided by an operating system 31 that operates in memory 30. One or more programmed software applications, herein referred to as applications, are executed by utilizing the computing resources in the DHCT 16. The application executable program stored in memory 30 is executed by processor 24 (e.g., a central processing unit or digital signal processor) under the auspices of the operating system 31. Data required as input by the application program is stored in memory 30 and read by processor 24 from memory 30 as need be during the course of application program execution. Input data may be data stored in memory 30 by a secondary application or other source, either internal or external to the DHCT 16, or possibly anticipated by the application and thus created with the application program at the time it was generated as a software application program. Data may be received via any of the communication ports of the DHCT 16, from the headend 11 via the DHCT's network interface (i.e., the QAM or out-of-band tuners) or as subscriber input via receiver 26. A type of input data fulfills and serves the purpose of parameters as described below. Data generated by application program is stored in memory 30 by processor 24 during the course of application program execution. Availability, location and amount of data generated by a first application for consumption by a secondary application is communicated by messages as described below. Messages are communicated through the services of the operating system, such as interrupt or polling mechanisms or data sharing mechanisms such as semaphores.

A Navigator (application) 33 is responsible for providing the subscriber the capability to select services and also provides a core functionality of the DHCT 16, including volume and settings. To implement its functionality, the Navigator 33 communicates with a platform 35, which is a collection of functionality such as the services application manager (SAM) 36, a Configuration Manager 42, and a Window Manager 45 that is useful to the applications. The platform 35 may also include such functionality as a Timer Manager, a Compression Manager, an HTML Parser, a Database Manager, A Widget Toolkit, and other utilities (not shown).

In one implementation, the Window Manager 45 maintains, among other things, a user input registry 32 so that when a subscriber enters a key or a command via the remote device 27 or another input device such as a keyboard or mouse, the user input registry 32 is accessed to determine which of various applications running on the DHCT 16 should receive the inputted key and it what order. The Navigator 33 registers for certain user input commands with the Window Manager 45 so that when the subscriber hits a key corresponding to one of the commands on the remote 27, the command is received by the receiver 26 and relayed to the processor 24. The processor 24 dispatches the event to the operating system 31 where it is forwarded to the Window Manager 45 which ultimately accesses the user input registry 32 and routes the incoming command to the Navigator 33. The Navigator 33 registers for user input commands that correspond to service navigation functions such as selecting a channel (channel increment, channel decrement, favorite, last) and those for other reserved functionality such as a key to activate the program guide.

After the Navigator 33 is activated by the remote 27, it sends a command to a services application manager (“SAM”) component 36 part of the platform 35. The SAM 36 maintains a services database 37 of all services available on the DHCT 16 that the subscriber may access and also comprises Daemon 34. A service is a pairing of an application and a parameter, such as a WatchTV application (not shown) and the television program to tune (e.g. NBC), or an E-mail application (not shown) and the IP address of the E-mail server. When the SAM 36 receives a query from the Navigator 33, it accesses the service database 37 and informs the Navigator 33 about the existence and status of the requested service. The Navigator 33 can further query the SAM 36 to determine if the service is authorized for the DHCT 16 and, if so, subsequently command the SAM 36 to activate the service. In response, the SAM 36 initiates an activate service message to the application identified in the service database as the provider of the desired service. As a non-limiting example, the subscriber pressing a “GUIDE” key on the remote 27 would activate the interactive program guide (application) 38. That is, the subscriber presses a first key that invokes display of an interactive program guided (IPG) 38 presentation session.

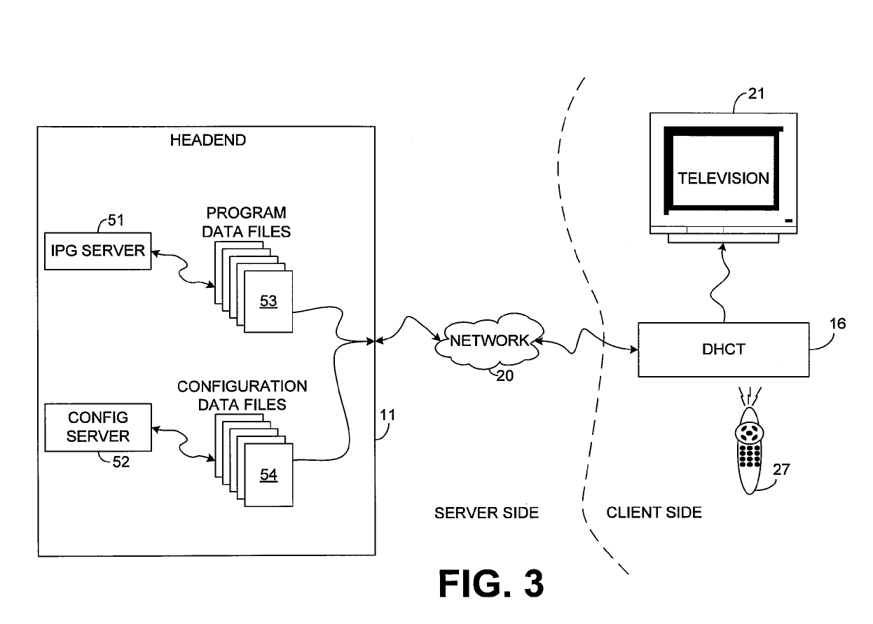

The IPG 38 displays a program guide to the subscriber and populates the guide with program data for selection. Contained in the IPG 38 is a user interface component 39 that controls the screen display presented to the subscriber on display 21. When the user interface 39 receives the activation message from the SAM 36, the user interface 39 proceeds in accessing an IPG database 40 and a configuration module 41 to determine the appropriate program guide configuration (initial guide arrangement or view) to present to the subscriber on the display 21. The IPG database 40 contains program data files of current and future television programs. An IPG configuration module 41 stores settings that the user interface 39 will implement in creating the display for the subscriber. According to the preferred embodiment of the present invention, the IPG configuration module 41 includes a configuration database 43 of all configurations relevant to the IPG 38. The configuration library 42 allows applications to access configurations stored in other applications, such as the IPG configuration database 43. Some of these configurations are pre-loaded into DHCT 16 non-volatile memory before it is released to a subscriber for use in viewing television services. Additionally, configurations can be updated, added, or replaced in the DHCT 16 by communicating the configuration data files 54 (FIG. 3) from the headend 11 to Configuration Daemon 44 which writes the configuration data files 54 to the various application configuration databases, such as the IPG configuration database 43. Although the IPG configuration database 43 provides a variety of initial configurations that the IPG user interface 39 may implement, one of these is denoted as the selected configuration that is ultimately implemented by the user interface 39. The configuration daemon 44 on the platform 35 will update the application configuration databases, such as IPG configuration database 43, whenever the DHCT 16 is powered up or when the configuration daemon 44 receives an update message from the headend 11 with new settings for the configurations.

When the IPG user interface 39 receives the activate service command from the SAM 36 responsive to a user selecting the IPG from the remote 27, the IPG user interface 39 accesses the IPG configuration module 41 to determine which viewing arrangement to present to the subscriber on the display 21. Based on the configuration information stored in the configuration module 41, the user interface 39 utilizes the window manager 45 and other graphics utilities provided by the operating system 31 to draw the screen on the display 21. The window manager 45 is a component that in one embodiment is part of the platform 35, but in other embodiments may be part of the operating system 31. In addition to the user input registry mentioned previously, it contains functionality for managing screen real-estate and synchronizing the drawing done by multiple applications. The operating system 31 provides primitives to the user interface 39 to, for example, to create a rectangular region on display 21 and to draw into that rectangle graphics utilities such as lines, shadings and strings.

As a window is created on display 21 for presentation to the subscriber, the IPG user-interface 39 registers with the window manager 45 for particular user input commands that are required by the newly-created window on the display 21. The IPG 38 also contains a daemon 46 that receives program data files 53 from the headend 11, and the daemon 46 stores the program data files 53 in the database 40 for utilization by the user interface 39.

The Navigator application 33, IPG 38, and all other applications executed by the resources of the DHCT 16 comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, solid-state, magnetic, optical, electromagnetic, infrared, or semiconductor system, apparatus, device, or propagation medium, either internal to the DHCT 16 or externally connected to the DHCT 16 via one or more communication ports or network interfaces. More specific examples (a nonexhaustive list) of the computer-readable medium would include the following: an electrical connection (electronic) having one or more wires, a portable computer diskette (magnetic), a hard drive storage device (magnetic) a random access memory (RAM) (solid-state device), a read-only memory (ROM) (solid-state device), an erasable programmable read-only memory (EPROM or Flash memory) (multiple devices), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. Furthermore, any process descriptions or blocks in flow charts should be understood as representing modules, segments, or portions of code or programmed software which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

FIG. 3 is a diagram of selected components resident on the headend 11 and their interaction with the DHCT 16 on the client side of the network 20. An IPG server 51 is contained on the headend 11 and assembles program data files 53 for transmission across the network 20 to the IPG daemon 46 (FIG. 2) in the DHCT 16. The program data files 53 are the data files that contain information about the current and a range of future programs, including their prospective viewing times, descriptive information, channels etc. The IPG server 51 allows the system operator to configure how many days in advance for which the program data files 53 will contain programming information. A configuration server 52 maintains and transmits across network 20 configuration data files 54 that comprise a plurality of program guide arrangement definitions, as well as indication of a selected initial program guide arrangement for the display 21.

With reference to FIG. 2, the configuration daemon 44 receives the configuration information and stores it in the IPG configuration database 43 from which configuration module 41 accesses the information, as discusses above. The program data files 53 (FIG. 3) created by the IPG server 51 on the headend 11 are received by the IPG Daemon 46 which populates the IPG database 40 in memory 30 with the program data files 53 for utilization by the user interface 39 when commanded by the subscriber. Alternatively, the IPG database 40, or parts thereof may be stored in a storage device that is internal to the DHCT 16 or externally connected to the DHCT 16 via a communication port such as USB or IEEE-1394.

In FIG. 2 and FIG. 3, functionality of the various layers of software, including the operating system 31, platform 35, and applications such as the IPG 38 and Navigator 33 are generally present on both the client side and the server side of the cable television system. The Navigator 33 assists in providing basic cable services and navigation framework to the subscriber. The services available can include watching television and pay-per-view events, listening to digital music, and the interactive program guide 38 (FIG. 38). The Navigator 33 also allows subscribers to access the settings in the DHCT 16 (FIG. 2), including volume, parental control, VCR commands, etc. The operating system 31 is a resident operating system on the DHCT 16 and is provisioned for reception of multi-media over the broadcast and interactive cable networks and uses an open and modular platform to allow flexibility and customization. As a result, some features of the operating system 31 include real time multi-media reception, streaming and processing and additionally, multi-tasking capability, and an open platform. The operating system 31 also provisions the communication of data among different entities such as a multiplicity of applications executing the DHCT 16. The application interface system (AIS) or Platform 35 is a collection of end-to-end software interfaces enabling applications on the cable television system network 10. The SAM 36 provides an interface and mechanism through with applications can be developed, introduced on the network, defined as a service, downloaded to the DHCT 16, executed on the DHCT 16 and removed from the network. The AIS is an end layer of application and service management software components that an application must utilize to exist in the cable television system network 10. It also consists of resource access and management components generally required by applications in the cable television system network 10. None of the AIS components have any client-side subscriber-interface, although graphical subscriber interfaces can exist to access server-side components.

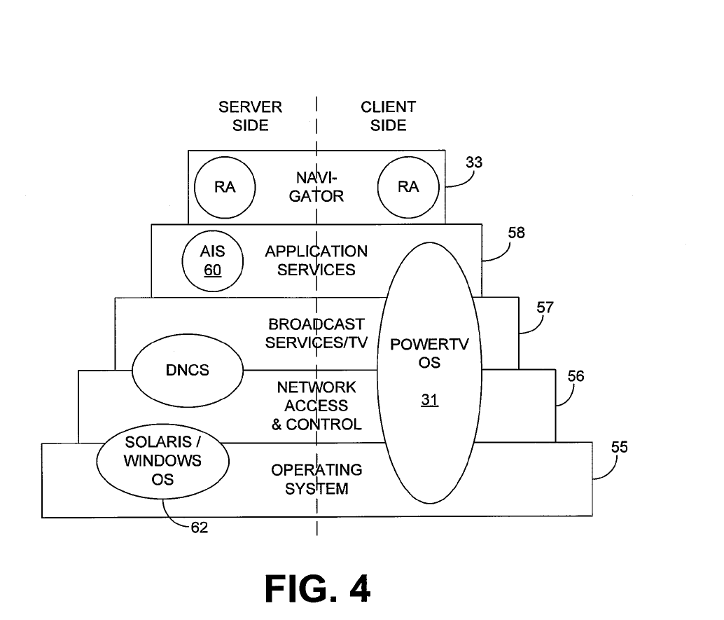

FIG. 4 is a diagram of the software support of the applications in the DHCT depicted in FIG. 2 and comprises Navigator 33, Application Services 58, Broadcast Services/TV 57, Network Access Control 56, and Operating System 55. On the Server Side the Application Interface System (AIS) 60 is under Application Services 58, and Solaris/Windows OS 62 is under both Network Control 56 and Operating System 55. On the Client Side, PowerTV OS 31 is under Application Services 58, Broadcast Services/TV 57, Network Access and Control 56, and Operating System 55.

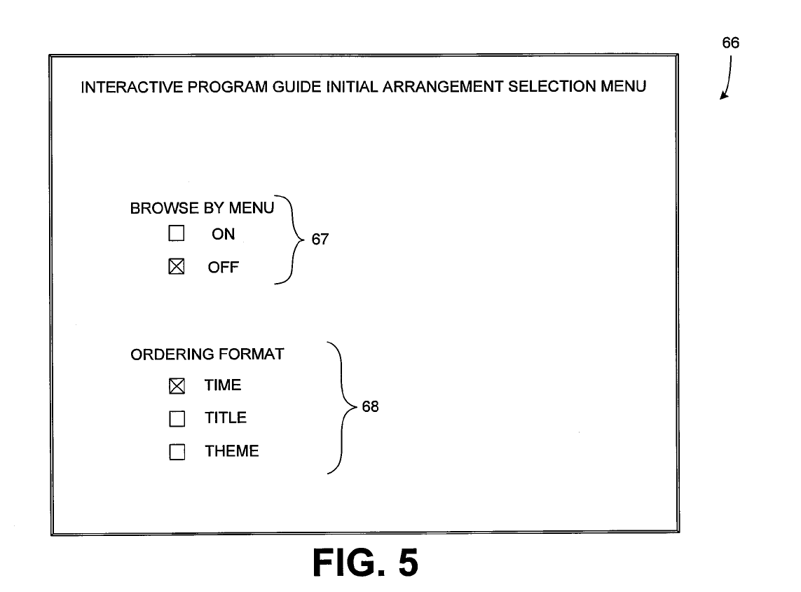

FIG. 5 is a diagram of the interactive program guide initial arrangement selection menu for a system operator at the headend 11 to configure which initial management, or view, a client device will implement in accordance with the present invention as depicted in FIG. 2. A system operator on the server side determines whether or not a browse-by menu feature is toggled on or toggled off 67, and whether the initial view is presented in a time, title, or theme ordering format 68. Both the browse-by menu option and the individual time, title and theme ordering formats will be discussed in more detail below.

As discussed above, the configuration server 52 (FIG. 3) provides an initial view configuration indication to the DHCT 16 as specified by a system operator, such as through menu 66, to indicate whether the initial guide arrangement is in time format, theme format, or title format, with or without a browse-by menu. That selection is communicated across the system network 20 to each individual DHCT 16. An alternative embodiment of the present invention permits the subscriber to define which initial view the subscriber desires to see as a default initial view each time the IPG 38 is activated on the display 21.

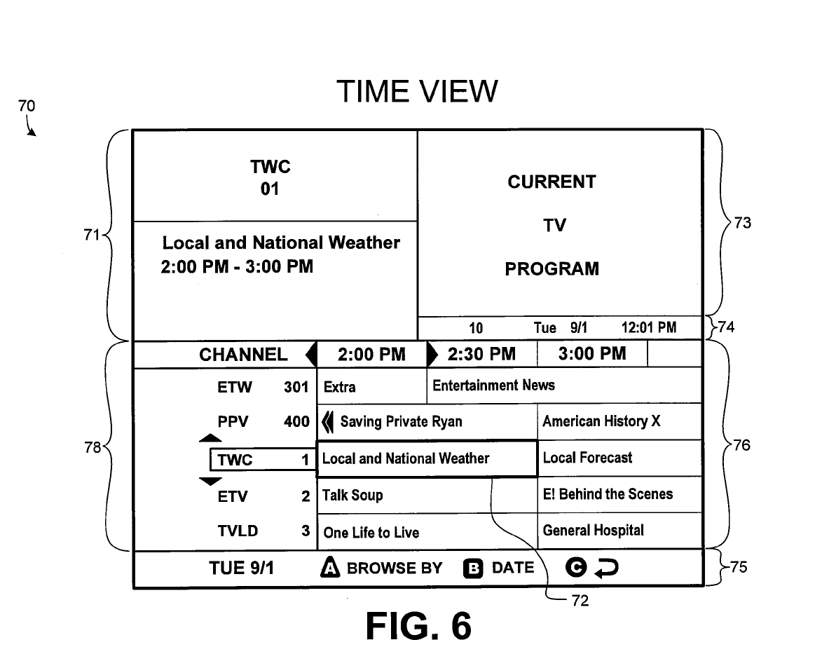

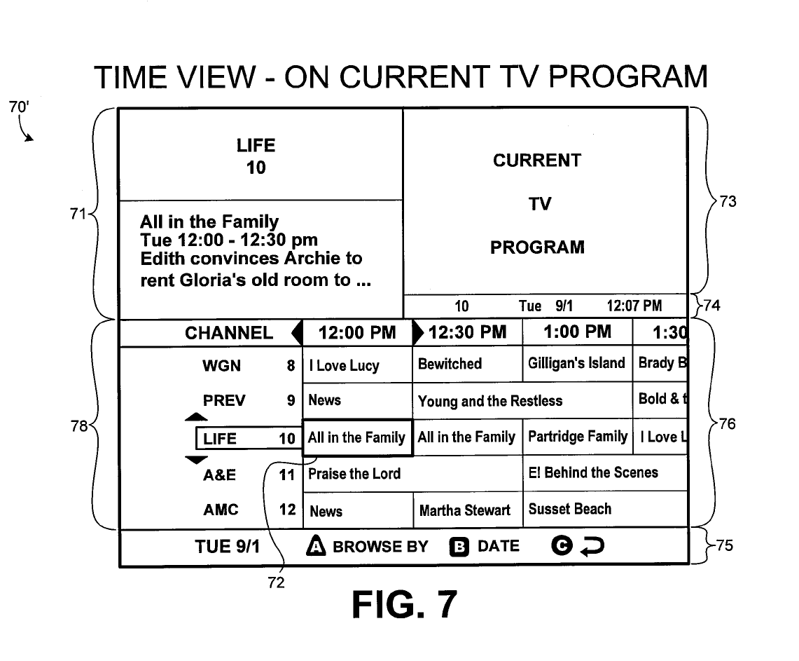

FIG. 6 is an example screen diagram that illustrates the initial guide arrangement in a time format that the DHCT as depicted in FIG. 2 presents the subscriber. The top left quarter of the main IPG display 70 is a detailed focus area 71 that includes detailed channel information (channel number, channel name (TWC), program name, program description, duration, any episode information or rating, etc.) for an “in-focus” program corresponding to highlighted program area 72 in a main program display area 76. Video showing on the channel to which the DHCT 16 is currently tuned (for which audio is also playing, and which is typically the program occupying the full screen before the IPG 38 is activated) is displayed in a one-quarter screen current program video area 73 in the IPG display 70. Immediately below the current program video area 73 is an information banner 74 depicting the channel to which the DHCT 16 is currently tuned, the current day and date, and the current time. The middle left portion of the IPG display 70 includes an ordering area 78 that is related to the selected ordering format and is described in more detail below. The bottom area 75 of IPG display 70 indicates the selected day for which program data is being displayed as well as the options for the “A”, “B”, and “C” keys on the remote 27 (FIG. 2). The “A” key is shown assigned to invoke a “Browse-by” menu which would function as discussed below. The “B” key enables the subscriber to select a different date for viewing program data via the IPG display 70. Operation of the “C” key results in a displaying of the screen shown in FIG. 7, as discussed below.

In the time view, the main program display area 76 includes program names organized in a grid of rows of channels and columns of time. The ordering area 78 includes a vertical list of channels organized sequentially from top to bottom by increasing channel number. The main program display area 76 can be scrolled in both time and channel number dimensions. The time dimensions are a horizontal array of program names categorized in columns of times in which they are broadcast. As the subscriber scrolls in time across a calendar day boundary, the selected day displayed in various areas is automatically updated.

When the IPG 38 is first activated by the subscriber and the time view is configured to be the initial view, the first, or lowest, channel, including channel name and number, in the channel lineup is centered in the channel portion of the IPG display 78. In this non-limiting example, the lowest channel in this channel list displayed in the ordering area 78 is The Weather Channel (TWC), which is shown as channel 1. Continuing with this non-limiting example, the left-most time column is set for two hours in the future, for example, making the “in-focus” program on the lowest channel, The Weather Channel, two hours in the future, centered and highlighted as highlighted program area 72. It should be noted that the current program shown in current program video area 73 and referenced in information banner 74, corresponds to channel 10 at 12:01 p.m., does not match the in-focus program on channel 1 at 2:00 p.m.

FIG. 7 is an example screen diagram that illustrates the IPG display 70′ in a modified time format for a current television program presented to a subscriber subsequent to the IPG display 70 in FIG. 6. In this non-limiting example, the ordering area 78 and the main program display area 76 have been configured to the current TV program shown in the current program video area 73. A subscriber may determine to bring the current program in-focus by initiating an input, such as pressing the “C” key on the remote 27 (FIG. 2) subsequent to the input that initially displayed the IPG screen 70 in FIG. 6. Thus, in this non-limiting example, the channel number “10” is centered in the ordering area 78, and the current TV viewing program, which in this case is All in the Family, is highlighted in the highlighted program area 72 under the current time viewing slot of 12:00 p.m. The detailed focus area 71 of the IPG display 70′ reveals information for All in the Family. The function of setting the “in-focus” program to be the currently showing program can be activated at any point in time while the subscriber is navigating the IPG display 70′.

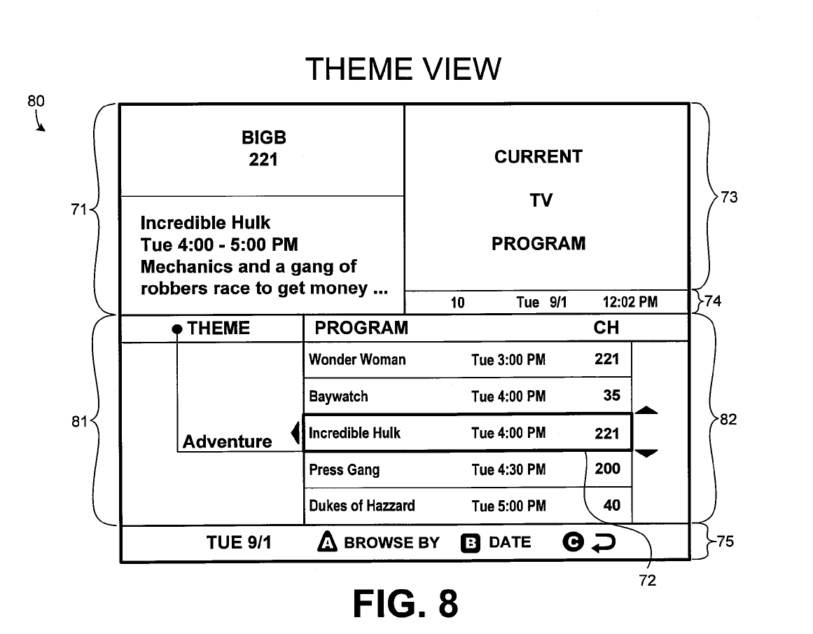

FIG. 8 is an example screen diagram that illustrates the initial guide arrangement for the IPG display 80 in a theme format that the DHCT as depicted in FIG. 2 presents the subscriber. In the non-limiting example shown in FIG. 8, the first alphabetical theme in the category of themes is initially selected and displayed in the ordering area 81. In the example shown, the Adventure theme is the first theme displayed. The first program in the current theme category, which in this case is the Adventure category, that starts after the current time displayed by the information banner 74 is listed at the top of the list in the main program display area 82. The highlighted program area for the “in-focus” program 72 is then the program centered in the list of programs in the main program display area 82.

If the subscriber wants to view a theme other than the current theme displayed in the ordering area 81, a separate input via the remote 27 directs the DHCT 16 to display multiple themes to a subscriber by moving the cursor 72 to the theme column in the ordering area 81. The ordering area 81 enables a subscriber to identify a theme from a scrolling list of themes (not shown) from which the subscriber may select an individual theme for a selected date. The programs in the main program display area 82 for the selected theme in the ordering area 81 are arranged sequentially by broadcast time.

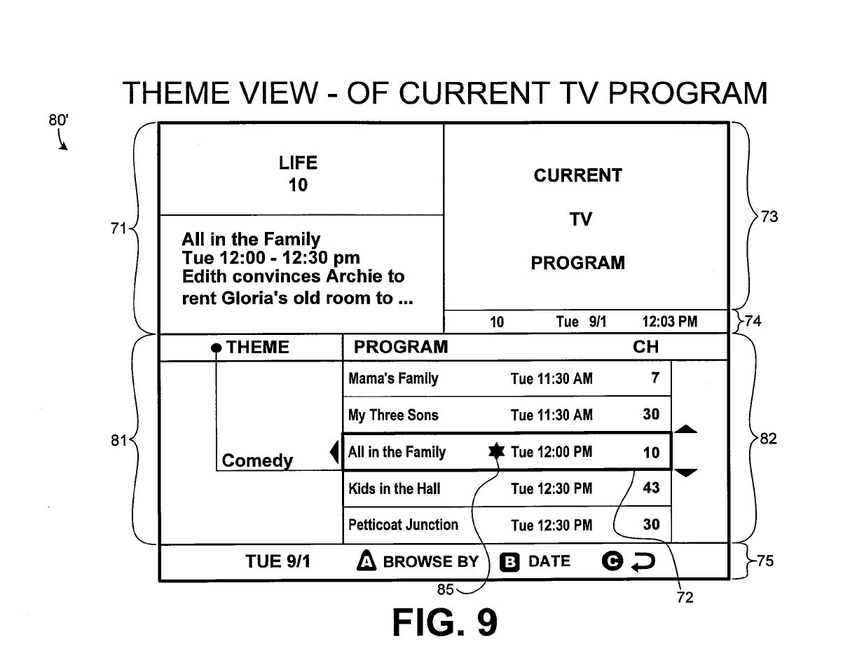

FIG. 9 is an example screen diagram of the IPG display 80′ that illustrates the guide arrangement in a modified theme format for a current television program presented to a subscriber subsequent to the guide arrangement in FIG. 8. In this non-limiting embodiment, a subscriber may direct the IPG user-interface 39 to locate the theme for the currently tuned TV by initiating an input, such as pressing the “C” key on the remote 27 (FIG. 2) subsequent to the input that initially displayed the IPG screen 80 in FIG. 8. A star 85 is included in the main program display area 82 to denote program currently showing on one of the channels available to the subscriber. The theme that corresponds to the “in-focus” program centered in the highlighted program area 72 is highlighted and centered in the theme portion of the display 81. Detailed program information is displayed for the program that is highlighted by the highlighted program area 72 in the detailed focus area 71 of the IPG display 80′. The subscriber may utilize the remote 27 to scroll between different themes in the ordering area 81, and the subscriber may also utilize the remote 27 to scroll up and down to different programs in the main program display area 82 for each respective theme. The function of setting the “in-focus” program to be the currently showing program can be activated at any point in time while the subscriber is navigating the theme-oriented IPG display 80′.

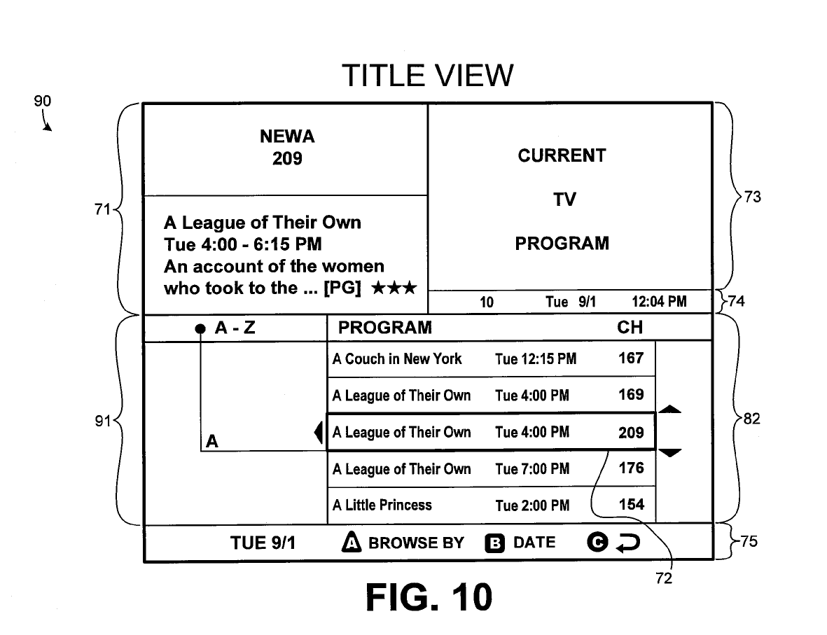

FIG. 10 is an example screen diagram of an IPG display 90 that illustrates the initial guide arrangement in a title format. Generally, the title format allows a subscriber to search for programs by title. Just as above, the detailed program information for the “in-focus” program is displayed in the detailed focus area 71. Similarly, video for the channel that is currently tuned by the DHCT 16 is displayed in current program video area 73 with the current channel number, day, date and time displayed in the information banner 74. In an ordering area 91 is an alphabetical list (A, B, C . . . Z, 0-9) wherein the subscriber can select the alphabetical category desired. In the main program display area 82, a list of programs (including program title, day, time, and channel number) in the category are ordered alphabetically for the selected date and can be scrolled by the subscriber. Although not shown in this non-limiting example in FIG. 10, programs that are currently showing on the given channel are denoted by a star.

Continuing with this non-limiting example, if the title format is the view that is the initial guide arrangement, the DHCT 16 displays the first alphabetical category (“A”) as the first selected category in the ordering area 91. In the main program display area 82, the first program in that category starting after the current time is displayed alphabetically at the top of the list in the main program display area 82. The highlighted program area 72 is centered in the main program display area 82 enabling the subscriber to scroll up and down to the various programs listed under the category selected in the title portion of the ordering area 91. Thus, a subscriber may navigate by using the remote 27 (FIG. 2) to select the various alphabetical title categories in the ordering area 91, or a subscriber may also navigate the various programs listed in the main program display area 82 that correspond to each respective title category for locating the desired television program for viewing.

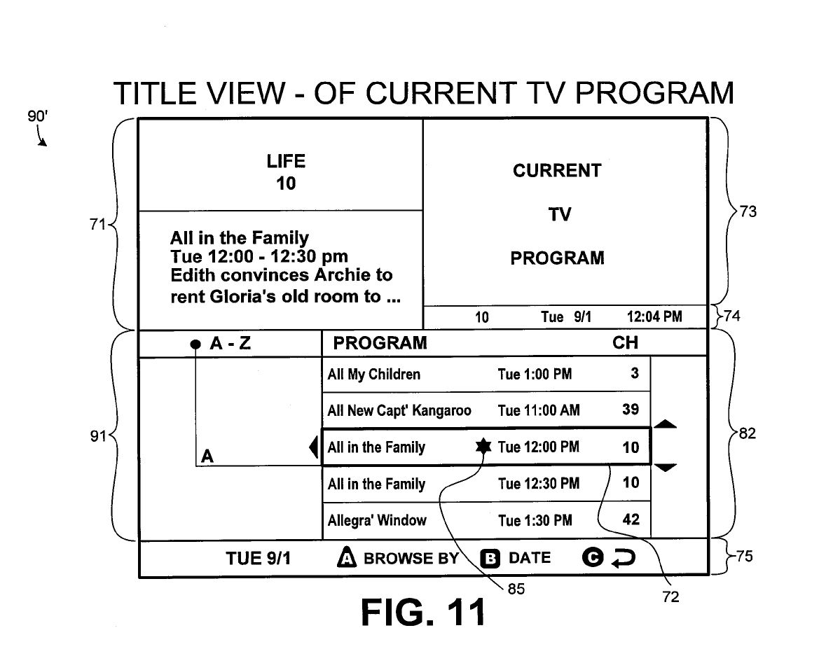

FIG. 11 is an example screen diagram of the IPG display 90′ that illustrates the guide arrangement in a modified title format for a current television program presented to a subscriber subsequent to the guide arrangement in FIG. 10. In this non-limiting embodiment, the currently tuned program becomes the “in-focus” program centered in the main program display area 82 and is highlighted in the highlighted program area 72. Because this program is the program that is currently tuned by the DHCT 16, a star 85 is included in the listing to denote that that program is currently available for viewing. The alphabetical category that corresponds to the “in-focus” program is highlighted and centered in the alphabetical list in the ordering area 91. Continuing with this non-limiting example, in this case, the currently showing program is the program All in the Family. Thus, All in the Family is centered and highlighted in the highlighted program area 72 and the title category “A” is displayed in the ordering area 91. The program data information that corresponds to the program, All in the Family, is displayed in the detailed focus area 71. The function of setting the “in-focus” program to be the currently showing program can be activated at any point in time while the subscriber is navigating the IPG display 90′.

As described previously, in the preferred embodiment, the default “in-focus” position is the currently showing program on the channel to which the DHCT 16 is tuned, for the time, theme, and title views. The subscriber can return the IPG display 90′ to this state by actuating a particular function key on the remote 27 such as the “C” key. An alternate embodiment of this invention may have a different default or home position, possibly for each view. For example, the default position in the theme view may have the cursor highlighting 72 the first available theme category in the theme list on the left, and the default position in the title view may have the cursor highlighting the first alphabetical category (“A”) in the title view.

A further alternative embodiment provides the subscriber, in response to actuating a particular function key on the remote 27 such as the “C” key, a list of default positions that can be selected. These positions may include, but are not limited to, the currently showing program in-focus, the first category of the relevant view highlighted, a favorite category the user has previously defined, or a recommended program in line with the user's television watching habits.

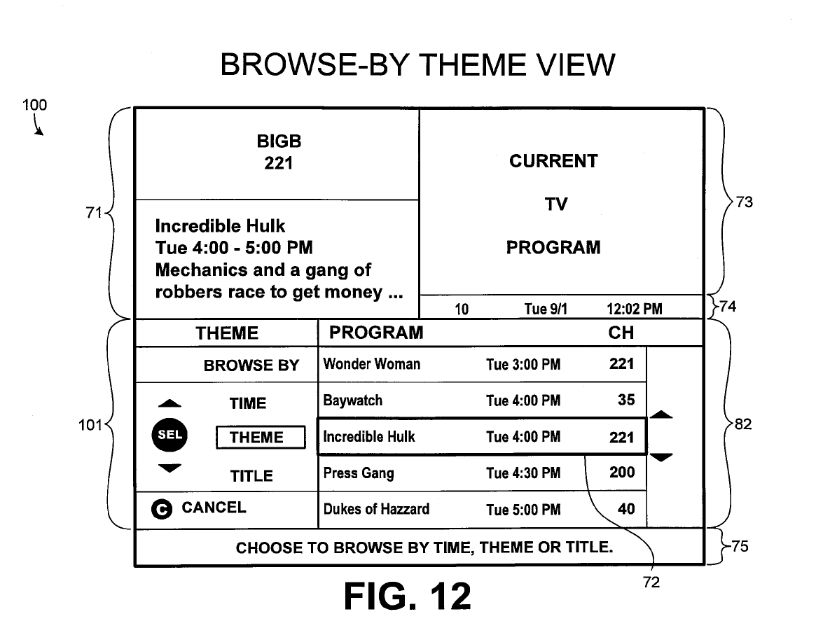

FIG. 12 is an example screen diagram of the IPG display 100 that illustrates the initial guide arrangement with the browse-by menu display overlaid on the theme format for a current television program that the DHCT 16 presents to the subscriber. A browse-by menu 101 of the IPG screen 100 enables the subscriber to scroll and choose to display a time view, a theme view, or a title view similar to those views described above. The browse-by menu portion 101 initially takes the place of the ordering area 78, 81, 91 as shown in FIGS. 6-11. The current television program tuned by the DHCT 16 is displayed in the current program video area 73 with the current information banner 74.

In addition, from this initial guide selection in browse-by theme format, the subscriber may select either the time, theme, or title view by input, such as through the “select” key, from the remote 27. For example, if the subscriber “selects” the theme view from the browse-by menu 101, the IPG screen 80′ of FIG. 9 is displayed with the currently tuned program becoming the “in-focus” program and is highlighted and centered in the highlighted program area 72 in the main program display area 82. Similarly, if the subscriber chooses to transition to either the title or time view via the browse-by menu 101, the currently showing program does not change; however, the “in-focus” program in the destination view changes to the currently showing program as shown in FIG. 7 for the time view and FIG. 11 for the title view.

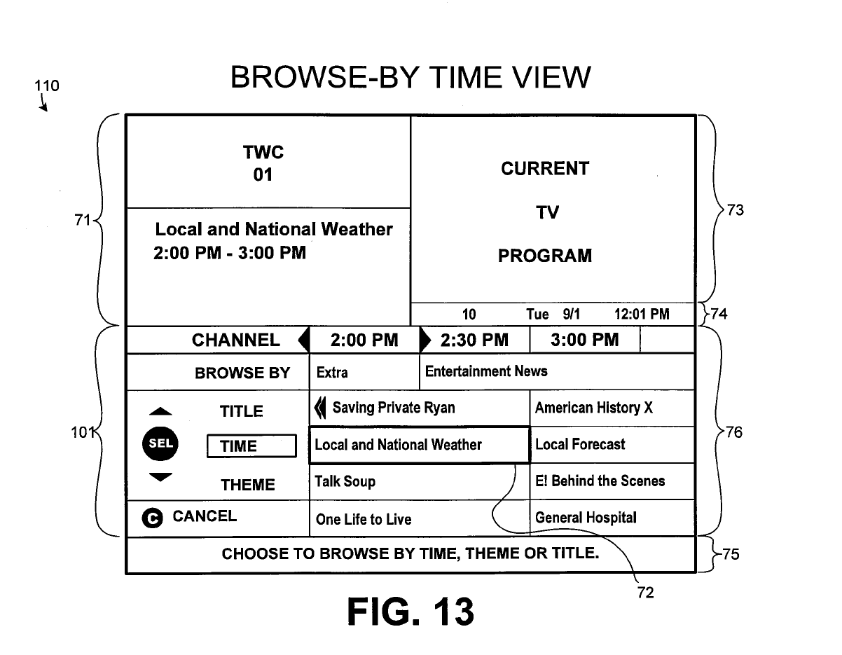

FIG. 13 is an example screen diagram of the IPG display 110 that illustrates the initial guide arrangement in a browse-by view time format for a current television program that the DHCT 16 as depicted in FIG. 2 presents the subscriber. As stated above, the browse-by menu 101 of the IPG screen 110 enables the subscriber to scroll and select a time view, a theme view, or a title view similar to those views described above. The browse-by menu portion 101 initially takes the place of the ordering area 78, 81, 91 as shown in FIGS. 6-11. The current television program tuned by the DHCT 16 is displayed in the current program video area 73 with the current information banner 74. The browse-by menu 101 can be scrolled so that the cursor highlights time, theme, or title and the IPG display otherwise is not changed.

Additionally, from this initial guide selection in browse-by time format, the subscriber may select either the time, theme, or title view by input, such as through the “select” key, from the remote 27. For example, if the subscriber “selects” the time view from the browse-by menu 101, the IPG screen 70′ of FIG. 7 is displayed with the currently tuned program becoming the “in-focus” program and is highlighted in the highlighted program area 72 in the main program display area 82.

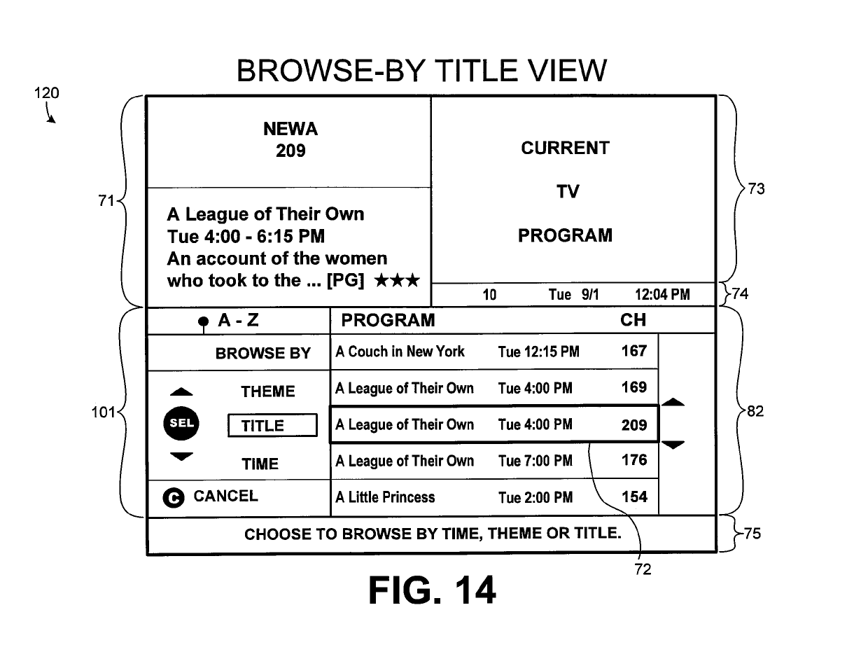

FIG. 14 is an example screen diagram of the IPG display 120 that illustrates the initial guide arrangement in a browse-by view title format for a current television program that the DHCT 16 as depicted in FIG. 2 presents the subscriber. As stated above, the browse-by menu 101 of the IPG screen 120 enables the subscriber to scroll between a time view, a theme view, and a title view similar to those views described above. The browse-by menu portion 101 initially takes the place of the ordering area 78, 81, 91 as shown in FIGS. 6-11. The current television program tuned by the DHCT 16 is displayed in the current program video area 73 with the current information banner 74. A scrolling transition to either the browse-by time or theme view via the browse-by menu 101 does not change the “in-focus” or currently showing program.

Additionally, from this initial guide selection in browse-by title format, the subscriber may select either the time, theme, or title view by input, such as through the “select” key, from the remote 27. For example, if the subscriber “selects” the title view from the browse-by menu 101, the IPG screen 90′ of FIG. 11 is displayed with the currently tuned program becoming the “in-focus” program and is centered and highlighted in the highlighted program area 72 in the main program display area 82.

In an alternative embodiment, initial guide arrangements may be configured for a variety of formats in addition to those described above based on types of programming, such as news programs, sports programs, movie programs, etc. As a non-limiting example, an initial guide arrangement can be configured for movie programming depicting a set of movies by channel versus broadcast time. Other configurations include initial guide arrangements with a set of movies displayed by title and a set of movies displayed by theme. The set of movies may be configured to include both all movies purchasable for fee and regular broadcast or merely movies of a distinct set that are purchasable and free.

In an alternate embodiment, the subscriber selects and saves a mode from one or more configurable modes in which an IPG 38 presents the initial guide arrangement each time the subscriber invokes an IPG display session. Responsive to a first subscriber input, a first configurable mode displays an initial guide arrangement that lists a multiplicity of guide arrangements in which the subscriber provides secondary input to select a desired guide arrangement to initiate the current IPG session. Responsive to a first subscriber input, a second configurable mode displays an initial guide arrangement corresponding to the last guide arrangement effective at the time of exiting the last IPG display session. Responsive to a first subscriber input, a third configurable mode displays an initial guide arrangement corresponding to a preferred guide arrangement selected by subscriber during an interactive configuration session from a multiplicity of guide arrangements.

It should be emphasized that the above-described embodiments of the present invention, particularly, any “preferred embodiments” are merely possible examples of the implementations, merely setting forth for a clear understanding of the principles of the inventions. Any variations and modifications may be made to the above-described embodiments of the invention without departing substantially from the spirit of the principles of the invention. All such modifications and variations are intended to be included herein within the scope of the disclosure and present invention and protected by the following claims.

What is claimed:

1. A method comprising:
displaying, on a display screen, program information related to a plurality of television programs, the program information for each television program including at least a title of the television program, a start time of the television program, and a channel on which the television program can be viewed;
receiving an activation instruction from a viewer to change the display screen from a program view predominantly showing the program information;
receiving an arrangement instruction from the viewer to display the program information in one of at least two views including at least a time view and a view other than the time view, the time view presenting the program information based on start times and listed in an order based on channel numbers;
receiving an initial-IPG-view instruction from the viewer to select one of the at least two views as an initial view when the display screen is initially changed to an IPG view; and
responsive to receiving the activation instruction from the viewer, displaying the program information in the initial view selected by the viewer.

2. The method of claim 1, further comprising:
enabling the viewer to select an option to display a last IPG view in effect at the time of exit from a first IPG view, in response to receiving the activation instruction when the display screen has been changed back from the first IPG view to the program view predominantly showing a television program.

3. The method of claim 1, further comprising:
responsive to receiving the arrangement instruction, displaying the program information in one of at least three views including at least the time view, a theme view, and a title view presenting the program information of television programs within a current and future time period and listed in alphabetical order.

4. The method of claim 1, wherein the view other than the time view is a theme view which presents a theme name and the program information of television programs within a particular theme category and listed in an order based on start time.

5. The method of claim 4, further comprising:
receiving an initial-theme-view instruction from the viewer for selecting an initial arrangement of the theme view when the theme view is initially presented.

6. The method of claim 5, wherein the initial arrangement of the theme view is based on a currently showing television program.

7. The method of claim 5, wherein the initial arrangement of the theme view is based on an alphabetical listing of current television programs.

8. The method of claim 5, wherein the initial arrangement of the theme view is based on a favorite category.

9. The method of claim 8, further comprising a favorite selection step that enables the viewer to select the favorite category.

10. A set-top terminal (STT) comprising:
a memory configured to store program instructions; and
a processor configured by the program instructions to:
display, on a display screen, an interactive program guide (IPG) including program information related to a plurality of television programs, the program information for each television program including at least a title of the television program, a start time of the television program, and a channel on which the television program can be viewed;
receive an activation instruction from a viewer to change the display screen from a program view predominantly showing the program information;
receive an arrangement instruction from the viewer to display the program information in one of at least two views including at least a time view and a view other than the time view, the time view presenting the program information based on start times and listed in an order based on channel numbers;
receive an initial-IPG-view instruction from the viewer to select one of the at least two views as an initial view when the display screen is initially changed to an IPG view; and
responsive to receiving the activation instruction from the viewer, display the program information in the initial view selected by the viewer.

11. The STT of claim 10, wherein the processor is further configured to:
enable the viewer to select an option to display a last IPG view in effect at the time of exit from a first IPG view, in response to receiving an activation instruction when the display screen has been changed back from the first IPG view to the program view predominantly showing a television program.

12. The STT of claim 10, wherein the processor is further configured to:
responsive to receiving the arrangement instruction, display the program information in one of at least three views including at least the time view, a theme view, and a title view presenting the program information of television programs within a current and future time period and listed in alphabetical order.

13. The STT of claim 10, wherein the view other than the time view is a theme view which presents a theme name and the program information of television programs within a particular theme category and listed in an order based on start time, wherein the processor is further configured to:
receive an initial-theme-view instruction from the viewer for selecting an initial arrangement of the theme view when the theme view is initially presented.

14. A method for selecting information related to a plurality of television programs for a viewer, the method comprising:
storing an interactive program guide (IPG) in a memory unit contained within a set-top terminal, the IPG configured to display, on a display screen, program information related to a plurality of television programs, the program information for each television program including at least a title of the television program, a start time of the television program, and a channel on which the television program can be view;
receiving a request from the viewer to display the program information in one of at least two views including at least a time view and a view other than the time view, wherein the time view presents the program information that is based on start times and that is listed in an order based on channel numbers;
receiving a request from the viewer to select an initial IPG view for defining one of the at least two views as an initial view when the display screen is changed from a program view predominantly showing a television program to an IPG view predominantly showing program information;
receiving a request from the viewer to change the display screen from the program view to the IPG view; and
displaying the program information in the initial view selected by the viewer in response to receiving the request to change the display screen to the IPG view.

15. The method of claim 14, wherein said view other than the time view is a theme view presenting a theme name and the program information of television programs within a particular theme category and listed in an order based on start time.

16. The method of claim 15, further comprising:
receiving an initial-theme-view instruction from the viewer for selecting an initial arrangement of the theme view when the theme view is initially presented.

17. The method of claim 16, wherein the initial arrangement of the theme view is based on a currently showing television program.

18. The method of claim 16, wherein the initial arrangement of the theme view is based on an alphabetical listing of current television programs.

19. The method of claim 16, wherein the initial arrangement of the theme view is based on a favorite category.

20. The method of claim 16, further comprising:
enabling the viewer to select an option to display a last IPG view in effect at the time of exit from a first IPG view when the display screen has been changed back from the first IPG view to the program view.
